(19) United States
(12) Patent Application Publication
(10) Pub. No.: US 2009/0283665 A1
(43) Pub. Date: Nov. 19, 2009

(54) IMAGE SENSOR WITH AN ALIGNED OPTICAL ASSEMBLY

(75) Inventor: Jaime I. Waldman, Pittsford, NY (US)

Correspondence Address: Peter P. Hernandez;Patent Legal Staff, Eastman Kodak Company, 343 State Street, Rochester, NY, 14650-2201, US

(73) Assignee: Eastman Kodak Company

(21) Appl. No.: 12/119,695

(22) Filed: May 13, 2008

(51) Int. Cl. H01J 3/14

(52) U.S. Cl. 250/216

(57) ABSTRACT

An image sensor includes a substrate; a photosensitive die having an array of photosensitive sites for receiving incident light; wherein the substrate extends beyond a boundary of the photosensitive layer for forming a mounting surface; a support, which includes a receiving portion, mounted to the substrate and surround at least a portion of the array of photosensitive sites; a transparent layer mounted in the receiving portion of the support; an optical assembly through which the incident light passes and includes at least three mounting structures which are mounted respectively to one mounting location on the support and two mounting locations on the mounting surface of the substrate for aligning the assembly to the array of photosensitive sites.

### FIELD OF THE INVENTION

The present invention relates to image sensors and, more particularly, to an optical assembly attached parallel or substantially parallel to an array of photosensitive sites of the image sensor to eliminate tilt of the optical assembly relative to the array of photosensitive sites.

### BACKGROUND OF THE INVENTION

Presently, image sensors include an array of photosensitive sites surrounded by an enclosing structure, typically made of plastic. Glass is mounted on the top of the enclosing structure, which in combination with the enclosing structure, totally encapsulates the array of photosensitive sites.

Typically, a lens and/or a filter is placed over the image sensor for either directing the incident light toward the array of photosensitive sites or filtering the light or a combination of both directing and filtering incident light. The lens or filter is mounted to the plastic enclosing structure by mounting extensions for rigidly mounting the lens and/or filter.

Although the presently known and utilized image sensor is satisfactory, it includes drawbacks. One drawback is that the mounting of the lens and/or filter to the plastic enclosing structure is not precise as desired and the lens and/or filter may tilt relative to the array of photosensitive sites. This causes the incident light to be directed inappropriately onto the array of photosensitive sites.

Consequently, a need exists for improving the mounting of the lens and/or filter to the plastic enclosing structure so that tilting is eliminated or substantially eliminated within desired tolerances.

### SUMMARY OF THE INVENTION

It is therefore an object of the present invention to provide an image sensor in which the optical assembly is aligned in such a way as to eliminate or substantially eliminate tilt of the optical assembly relative to the array of photosensitive sites.

This object is achieved by an image sensor having a substrate; a photosensitive die having an array of photosensitive sites for receiving incident light; wherein at least a portion of the substrate extends beyond a boundary of the silicon die for forming a mounting surface; a support, which includes a receiving portion, mounted to the substrate and surrounds at least a portion of the array of photosensitive sites; a transparent layer mounted in the receiving portion of the support; an optical assembly through which the incident light passes and includes at least three mounting structures which are mounted respectively to one mounting location on the support and two mounting locations on the mounting surface of the substrate for aligning the assembly to the array of photosensitive sites.

### ADVANTAGES

The present invention provides the advantage of eliminating undesirable tilt of the optical assembly relative to the array of photosensitive sites.

### BRIEF DESCRIPTION OF THE DRAWINGS

FIG. 1 is a top view of the image sensor of the present invention;

FIG. 2 is a side view cut along line 2-2 of FIG. 1;

FIG. 3 is a side view cut along line 3-3 of FIG. 1;

FIG. 4 is a side view cut along line 4-4 of FIG. 4;

FIG. 5 is a top view of the image sensor of the present invention with the optical assembly removed; and

FIG. 6 is a schematic in block diagram form of an image capture device of the present invention having the image sensor of the present invention.

### DETAILED DESCRIPTION OF THE INVENTION

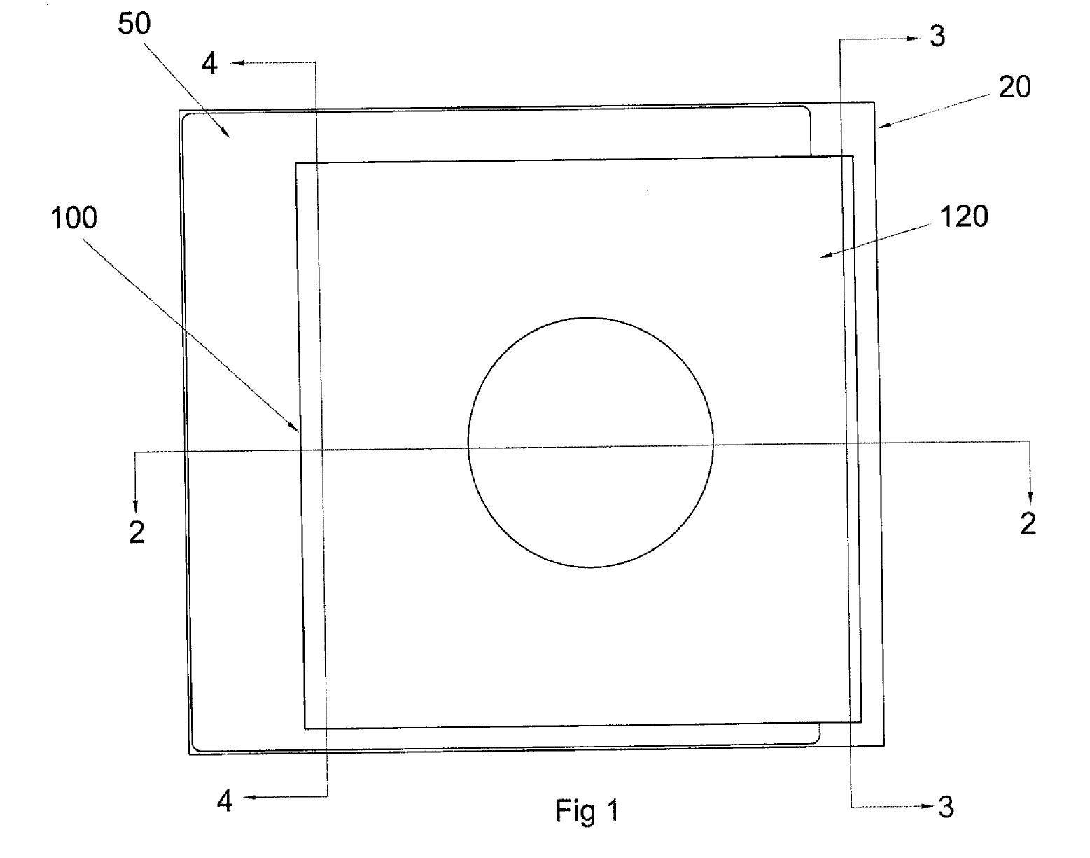

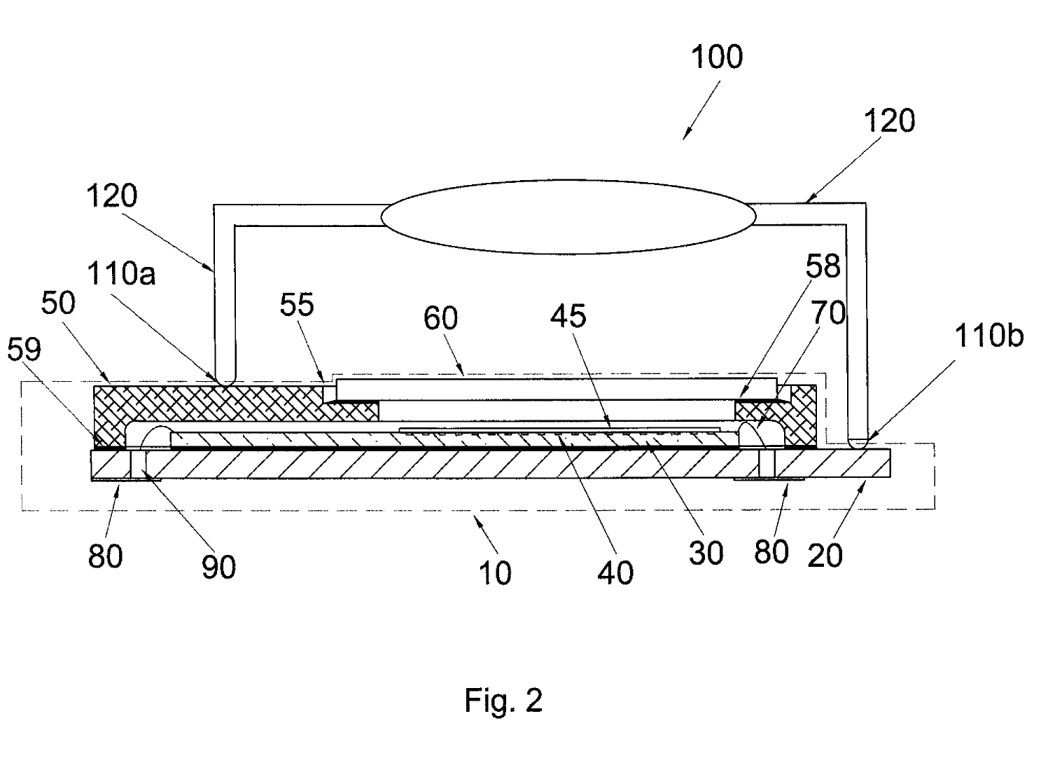

Referring to FIGS. 1 and 2, there is shown an image sensor 10 having a substrate 20 on which is mounted a photosensitive die 30, preferably silicon die, having an array of photosensitive sites 40 therein each for receiving incident light which releases charge in the silicon die in response to incident light, and the charge is captured respectively by each photosensitive site 40. The array of photosensitive sites 40 may be either charge-coupled devices or complimentary metal oxide semiconductor (commonly referred to as CMOS) both well known in the art. CMOS refers to the fact that CMOS uses complementary and symmetrical pairs of p-type and n-type metal oxide semiconductor field effect transistors (MOSFETs) typically for logic functions. A plurality of microlenses 45 are disposed over the photosensitive sites 40 for further directing the light on the photosensitive sites 40. It is noted that the photosensitive die 30 is placed and glued parallel to the substrate 20.

A support 50, preferably plastic, extends around the periphery of the photosensitive sites 40 and typically completely surrounds the photosensitive site 40. It is noted that a mating surface 59 of the plastic support 50 is placed and glued parallel to the substrate 20. The support 50 includes a receiving portion 55, preferably L-shaped, in which a transparent layer 60, preferably glass, is placed in the receiving portion 55. The transparent layer 60 is sealed to the receiving portion 55 by either glue, adhesive, epoxy or the like 58. The transparent layer 60 and the support 50 encloses the photosensitive die 30 on its top and side with the substrate 20 enclosing it from the bottom. A plurality of wire bonds 70 each extend from the periphery of the photosensitive die 30 to the substrate 20 and are each connected to a solderpad 80 via metal contacts 90, commonly referred to in the art as VIAs. The solderpads 80 permit the signal to be passed therefrom for further processing, as is well known in the art.

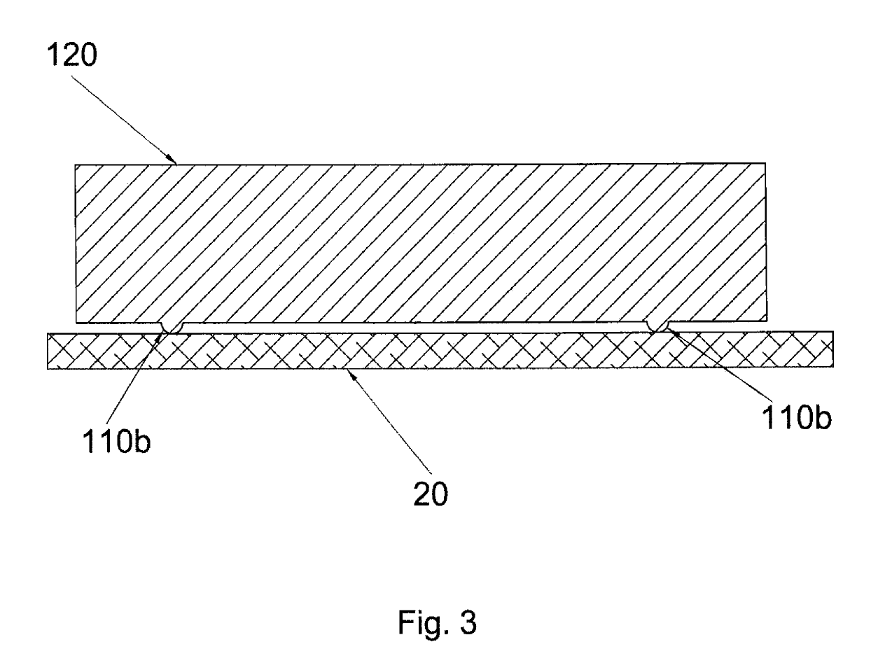

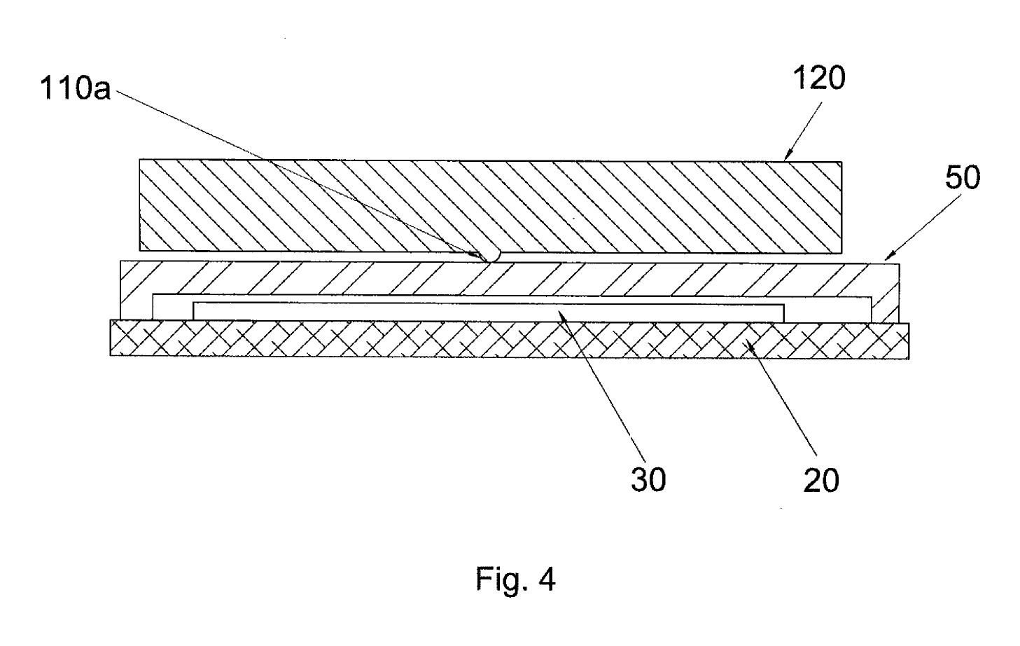

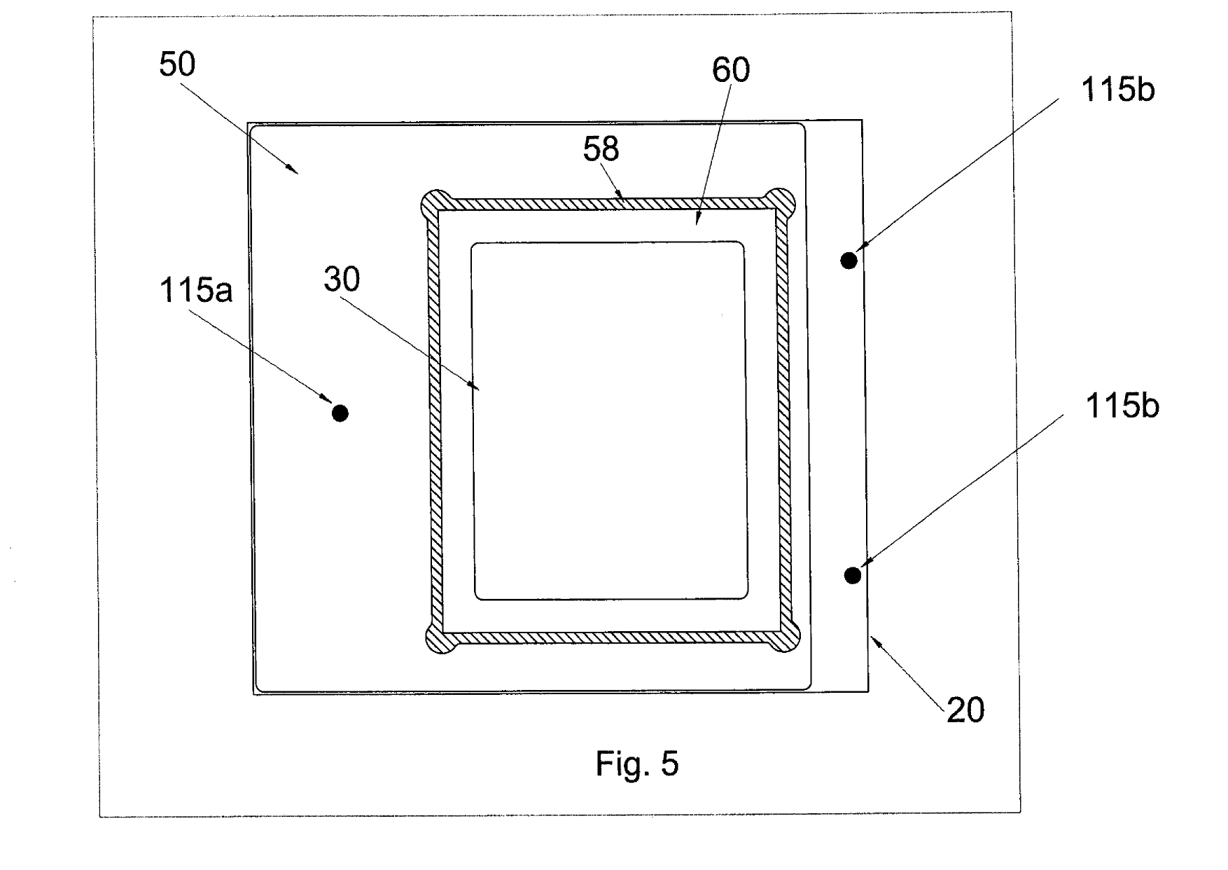

An optical assembly 100, which may be either a lens and/or a filter, is placed over the array of photosensitive sites 40 in the photosensitive die 30 and includes a mounting structure 120 having mounting extensions 110a and 110b (only two of which is visible in FIG. 2). Referring to FIG. 4, the mounting extension 110a is rigidly attached to the support 50 at one location, and referring to FIG. 3, the two mounting extensions 110b are rigidly attached to the substrate 20 at two locations. Referring to FIG. 5, it is noted that attachment of the mounting extensions 110b to the substrate 20 is at a mounting location 115b which is located beyond the support 50. The attachment of the mounting extension 110a is directly on the plastic support 50. These locations 115a and 115b may be marked with fiducials for efficient aligning of the photosensitive die 30 and the optical assembly 100 thereon.

Preferably, the location 115a on the plastic support 50 is substantially at a midpoint of the array of photosensitive sites 40 of the photosensitive die 30, and preferably the two mounting locations 115b on the mounting surface of the substrate 20 are each substantially at an edge of the array of photosensitive sites 40 of the photosensitive die 30. The placement of the optical assembly 100 to the array of photosensitive sites 40 is parallel or substantially parallel which alleviates tilting and the like. The two mounting locations 115b on the substrate 20 are aligned to the longer side of the image array.

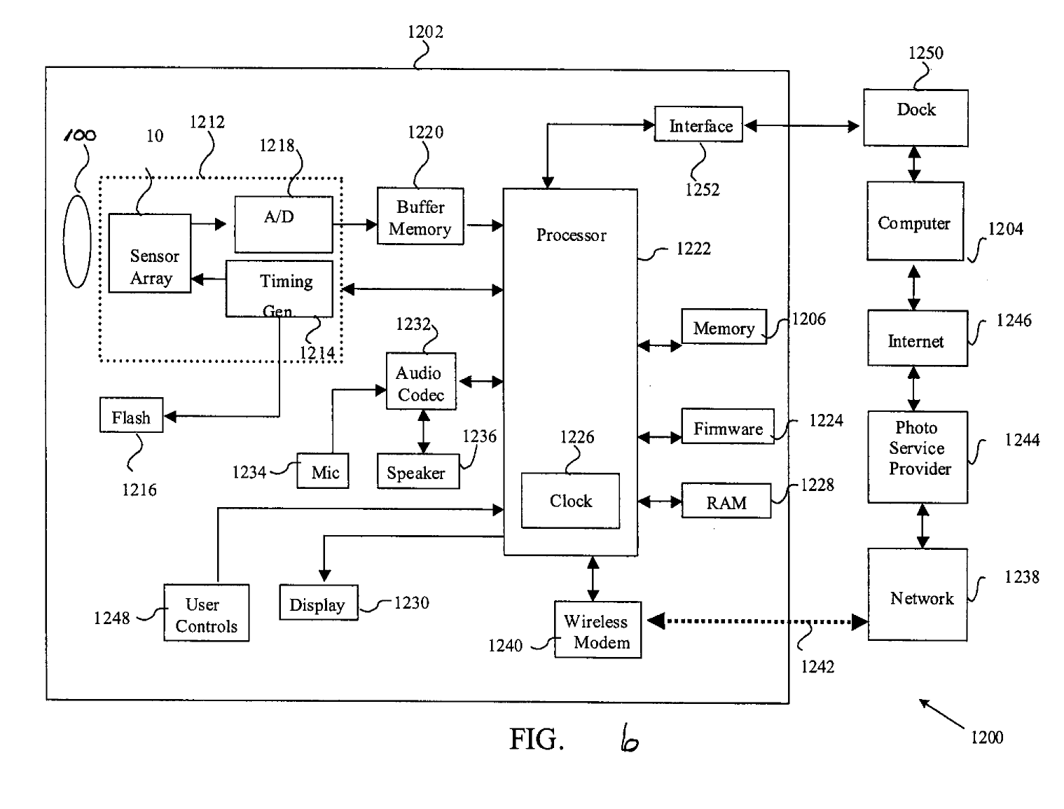

Referring to FIG. 6, there is shown a block diagram of an imaging system that can be used with the image sensor 10 in accordance with the present invention. Imaging system 1200 includes digital camera phone 1202 and computing device 1204. Digital camera phone 1202 is an example of an image capture device that can use an image sensor incorporating the present invention. Other types of image capture devices can also be used with the present invention, such as, for example, digital still cameras and digital video camcorders.

Digital camera phone 1202 is a portable, handheld, battery-operated device in an embodiment in accordance with the invention. Digital camera phone 1202 produces digital images that are stored in memory 1206, which can be, for example, an internal Flash EPROM memory or a removable memory card. Other types of digital image storage media, such as magnetic hard drives, magnetic tape, or optical disks, can alternatively be used to implement memory 1206.

Digital camera phone 1202 uses optical assembly 100 to focus light from a scene (not shown) onto the image sensor array 10 of pixel sensor 1212. Image sensor array 10 provides color image information using the Bayer color filter pattern in an embodiment in accordance with the invention. Image sensor array 10 is controlled by timing generator 1214, which also controls flash 1216 in order to illuminate the scene when the ambient illumination is low.

The analog output signals output from the image sensor array 10 are amplified and converted to digital data by analog-to-digital (A/D) converter circuit 1218. The digital data are stored in buffer memory 1220 and subsequently processed by digital processor 1222. Digital processor 1222 is controlled by the firmware stored in firmware memory 1224, which can be flash EPROM memory. Digital processor 1222 includes real-time clock 1226, which keeps the date and time even when digital camera phone 1202 and digital processor 1222 are in a low power state. The processed digital image files are stored in memory 1206. Memory 1206 can also store other types of data, such as, for example, music files (e.g. MP3 files), ring tones, phone numbers, calendars, and to-do lists.

In one embodiment in accordance with the invention, digital camera phone 1202 captures still images. Digital processor 1222 performs color interpolation followed by color and tone correction, in order to produce rendered sRGB image data. The rendered sRGB image data are then compressed and stored as an image file in memory 1206. By way of example only, the image data can be compressed pursuant to the JPEG format, which uses the known “Exif” image format. This format includes an Exif application segment that stores particular image metadata using various TIFF tags. Separate TIFF tags can be used, for example, to store the date and time the picture was captured, the lens f/number and other camera settings, and to store image captions.

Digital processor 1222 produces different image sizes that are selected by the user in an embodiment in accordance with the invention. One such size is the low-resolution “thumbnail” size image. Generating thumbnail-size images is described in commonly assigned U.S. Pat. No. 5,164,831, entitled “Electronic Still Camera Providing Multi-Format Storage Of Full And Reduced Resolution Images” to Kuchta, et al. The thumbnail image is stored in RAM memory 1228 and supplied to color display 1230, which can be, for example, an active matrix LCD or organic light emitting diode (OLED). Generating thumbnail size images allows the captured images to be reviewed quickly on color display 1230.

In another embodiment in accordance with the invention, digital camera phone 1202 also produces and stores video clips. A video clip is produced by summing multiple pixels of image sensor array 10 together (e.g. summing pixels of the same color within each 4 column×4 row area of the image sensor array 10 to create a lower resolution video image frame. The video image frames are read from image sensor array 1210 at regular intervals, for example, using a 15 frame per second readout rate.

Audio codec 1232 is connected to digital processor 1222 and receives an audio signal from microphone (Mic) 1234. Audio codec 1232 also provides an audio signal to speaker 1236. These components are used both for telephone conversations and to record and playback an audio track, along with a video sequence or still image.

Speaker 1236 is also used to inform the user of an incoming phone call in an embodiment in accordance with the invention. This can be done using a standard ring tone stored in firmware memory 1224, or by using a custom ring-tone downloaded from mobile phone network 1238 and stored in memory 1206. In addition, a vibration device (not shown) can be used to provide a silent (e.g. non-audible) notification of an incoming phone call.

Digital processor 1222 is connected to wireless modem 1240, which enables digital camera phone 1202 to transmit and receive information via radio frequency (RF) channel 1242. Wireless modem 1240 communicates with mobile phone network 1238 using another RF link (not shown), such as a 3GSM network. Mobile phone network 1238 communicates with photo service provider 1244, which stores digital images uploaded from digital camera phone 1202. Other devices, including computing device 1204, access these images via the Internet 1246. Mobile phone network 1238 also connects to a standard telephone network (not shown) in order to provide normal telephone service in an embodiment in accordance with the invention.

A graphical user interface (not shown) is displayed on color display 1230 and controlled by user controls 1248. User controls 1248 include dedicated push buttons (e.g. a telephone keypad) to dial a phone number, a control to set the mode (e.g. “phone” mode, “calendar” mode” “camera” mode), a joystick controller that includes 4-way control (up, down, left, right) and a push-button center “OK” or “select” switch, in embodiments in accordance with the invention.

Dock 1250 recharges the batteries (not shown) in digital camera phone 1202. Dock 1250 connects digital camera phone 1202 to computing device 1204 via dock interface 1252. Dock interface 1252 is implemented as wired interface, such as a USB interface, in an embodiment in accordance with the invention. Alternatively, in other embodiments in accordance with the invention, dock interface 1252 is implemented as a wireless interface, such as a Bluetooth or an IEEE 802.11b wireless interface. Dock interface 1252 is used to download images from memory 1206 to computing device 1204. Dock interface 1252 is also used to transfer calendar information from computing device 1204 to memory 1206 in digital camera phone 1202.

The invention has been described in detail with particular reference to certain preferred embodiments thereof, but it will be understood that variations and modifications can be effected within the spirit and scope of the invention.

### PARTS LIST

10 image sensor array
20 substrate
30 photosensitive die
40 photosensitive sites
45 microlenses
50 plastic support
55 receiving portion
58 glue or adhesive
59 mating surface
60 transparent layer or glass
70 wire bonds
80 solderpads
90 metal contacts or VIAs
100 optical assembly
110a mounting extensions
110b mounting extensions
115a mounting location
115b mounting location
120 mounting structure
1200 imaging system
1202 digital camera phone
1204 computing device
1206 memory
1210 image sensor array
1212 pixel sensor
1214 timing generator
1216 flash
1218 A/D converter circuit
1220 buffer memory
1222 digital processor
1224 firmware memory
1226 clock
1228 RAM memory
1230 color display
1232 audio codec
1234 microphone
1236 speaker
1238 mobile phone network
1240 wireless modem
1242 RF Channel
1244 photo service provider
1246 Internet
1248 user controls
1250 dock
1252 dock interface

1. An image sensor comprising:
(a) a substrate;
(b) a photosensitive die having an array of photosensitive sites for receiving incident light; wherein at least a portion of the substrate extends beyond a boundary of the photosensitive layer for forming a mounting surface;
(c) a support, which includes a receiving portion, mounted to the substrate and surrounds at least a portion of the array of photosensitive sites;
(d) a transparent layer mounted in the receiving portion of the support; and
(e) an optical assembly through which the incident light passes and includes at least three mounting structures which are mounted respectively to one mounting location on the support and two mounting locations on the mounting surface of the substrate for aligning the assembly to the array of photosensitive sites.

2. The image sensor as in claim 1, wherein the photosensitive layer is a silicon die.

3. The image sensor as in claim 1, wherein the transparent layer is glass.

4. The image sensor as in claim 1, wherein the location on the support is substantially at a midpoint of the array of photosensitive sites.

5. The image sensor as in claim 4, wherein the two mounting locations on the mounting surface of the substrate are each substantially at an edge of the array of photosensitive sites.

6. The image sensor as in claim 1, wherein the optical assembly is either a lens or a filter or a combination of the lens and filter.

7. The image sensor as in claim 1, wherein the alignment of the optical assembly to the array of photosensitive sites is substantially parallel.

8. The image sensor as in claim 1, wherein the alignment of the optical assembly to the array of photosensitive sites is relative to fiducials on the three mounting locations.

9. The image sensor as in claim 1, wherein the two mounting locations on the substrate are aligned to the longer side of the image array.

10. A method for forming an image sensor, the method comprising the steps of:
(a) providing a substrate;
(b) disposing a photosensitive die having an array of photosensitive sites for receiving incident light over the substrate and extending at least a portion of the substrate beyond a boundary of the photosensitive layer for forming a mounting surface;
(c) mounting a support, which surrounds at least a portion of the photosensitive sites, to the substrate and providing a receiving portion in the support;
(d) mounting a transparent layer in the receiving portion of the support; and
(e) aligning an optical assembly over the transparent layer through which optical assembly the incident light passes and providing at least three mounting structures which are mounted respectively to one mounting location on the support and two mounting locations on the mounting surface of the substrate for aligning the assembly to the array of photosensitive sites.

11. The method as in claim 10 further comprising the step of providing silicon die as the photosensitive layer.

12. The method as in claim 11 further comprising the step of providing glass as the transparent layer.

13. The method as in claim 10 further comprising the step of providing the location on the plastic at substantially a midpoint of the array of photosensitive sites.

14. The method as in claim 13 further comprising the step of providing the two mounting locations on the mounting surface of the substrate each substantially at an edge of the array of photosensitive sites.

15. The method as in claim 10 further comprising the step of providing the optical assembly as either a lens or a filter or a combination of the lens and filter.

16. The method as in claim 10 further comprising the step of aligning the assembly to the array of photosensitive sites in substantially parallel planes.

17. The method as in claim 10 further comprising the step of aligning the optical assembly to the array of photosensitive sites relative to fiducials on the three mounting locations.

18. The method as in claim 10 further comprising the step of providing the two mounting locations on the substrate aligned to the longer side of the image array.

19. An image capture device comprising:
an image sensor comprising:
(a) a substrate;
(b) a photosensitive layer having an array of photosensitive sites for receiving incident light; wherein at least a portion of the substrate extends beyond a boundary of the photosensitive layer for forming a mounting surface;
(c) a support, which includes a receiving portion, mounted to the substrate and surrounds at least a portion of the photosensitive sites;
(d) a transparent layer mounted in the receiving portion of the support; and
(e) an optical assembly through which the incident light passes and includes at least three mounting structures which are mounted respectively to one mounting location on the support and two mounting locations on the mounting surface of the substrate for aligning the assembly to the array of photosensitive sites.

20. The image capture device as in claim 19, wherein the image capture device is a digital camera.

21. The image capture device as in claim 19, wherein the image capture device is a cell phone.

22. The image capture device as in claim 19, wherein the photosensitive die is a silicon die.

23. The image capture device as in claim 19, wherein the transparent layer is glass.

24. The image capture device as in claim 19, wherein the location on the support is substantially at a midpoint of the array of photosensitive sites.

25. The image capture device as in claim 24, wherein the two mounting location on the mounting surface of the substrate are each substantially at an edge of the array of photosensitive sites.

26. The image capture device as in claim 19, wherein the optical assembly is either a lens or a filter or a combination of the lens and filter.

27. The image capture device as in claim 19, wherein the alignment of the assembly to the array of photosensitive sites is substantially parallel.

28. The image capture device as in claim 19, wherein the alignment of the assembly to the array of photosensitive sites is relative to fiducials on the three mounting locations.

29. The image capture device as in claim 19, wherein the two mounting locations on the substrate are aligned to the longer side of the image array.
